(19) United States
(12) Patent Application Publication
(10) Pub. No.: US 2010/0192026 A1
(43) Pub. Date: Jul. 29, 2010

(54) IMPLEMENTATIONS OF PROGRAM RUNTIME CHECKS

(75) Inventors: Martin Abadi, Palo Alto, CA (US); Ulfar Erlingsson, Reykjavik (IS); Daniel Luchaup, Madison, WI (US); Marcus Peinado, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/360,259

(22) Filed: Jan. 27, 2009

(51) Int. Cl. G06F 11/08

(52) U.S. Cl. 714/53; 714/E11.03

(57) ABSTRACT

Runtime checks on a program may be used to determine whether a pointer points to a legitimate target before the pointer is dereferenced. Legitimate addresses, such as address-taken local variables (ATLVs), global variables, heap locations, functions, etc., are tracked, so that the legitimate targets of pointers are known. The program may be transformed so that, prior to dereferencing a pointer, the pointer is checked to ensure that it points to a legitimate address. If the pointer points to a legitimate address, then the dereferencing may proceed. Otherwise, an error routine may be invoked. One example way to keep track of legitimate addresses is to group address-taken variables together within a specific range or ranges of memory addresses, and to check that a pointer has a value within that range prior to dereferencing the pointer. However, addresses may be tracked in other ways.

### BACKGROUND

A program may incorporate runtime checks. Such checks may be used for various purposes, such as helping to find bugs in the program, or verifying that the program's behavior conforms to certain standards.

In order to carry out these purposes or others, one issue that may arise at runtime is whether a pointer that is about to be dereferenced points to a legitimate target address. Languages that support pointers typically allow any, or almost any, value to be assigned to the pointer. However, the unfettered ability to point to any address in memory can lead to unexpected or unwanted program behaviors. A program could use pointers to access areas of the memory that the program is not supposed to access. Or, a pointer could be used to call an arbitrary function outside of the program's normal control flow. An attempt to dereference a pointer that has an unexpected value may suggest that the program has been attacked, or that the program is about to engage in an unknown or unexpected behavior.

### SUMMARY

The subject matter herein may be used to implement efficient runtime checks on pointers. Prior to dereferencing a pointer, a check may be performed to determine whether the pointer points to a legitimate target address. If the pointer does point to a legitimate target address, then the pointer is dereferenced and used in its normal manner. Otherwise, an error occurs. Various types of addresses could be considered legitimate pointer targets. However, the following are some examples of legitimate pointer targets. For a data pointer, an address may be considered a legitimate pointer target if it is the address of an address-taken variable (global or local) or if it is a location on the heap. And, for a function pointer, an address may be considered a legitimate pointer target if it is the starting address of a function. Thus, implementing runtime checks may involve being able to determine whether a pointer points to one of these items.

One way to determine whether a pointer points to an address-taken variable is to group the address-taken variables together into one range of addresses. Then, when the pointer is about to be dereferenced, the pointer can be tested to determine whether it falls into that range. A similar technique may be used for other legitimate pointer targets. For example, the starting and ending addresses of the heap are known, and thus it can be determined whether a pointer points to an address on the heap by testing whether the pointer's value lies between the heaps starting and ending addresses.

One way to group address-taken variables together is to convert address-taken local variables (ALTVs) into global variables and to store all global variables and ATLVs within a specific range of addresses. This solution may be used if recursion is avoided on functions that use ATLVs. However, if there are no restrictions on the use of recursion, then ATLVs may be stored on the stack—as they usually are—and the locations on the stack where the ATLVs are stored may be tracked so that a runtime check can compare a pointer value to the known legitimate stack locations of ATLVs. Keeping track of which locations on the stack contain ATLVs may be done in various ways. For example, each frame on the stack could be assigned a range in which the ATLVs for that frame are stored, and the frame could contain metadata specifying which range of addresses contains the ATLVs for that frame. Or, there could be a bitmap that specifies the locations on the stack that contain ATLVs, or that specifies other legitimate addresses that the pointer may point to.

Similar techniques may be used with function pointers. In one example, functions that are assigned to pointers are listed in a table. The table may be stored within a known range, and a pointer to a function may be replaced with a pointer to the table entry that corresponds to that function. Since the table is stored within a known range of addresses, the legitimacy of the function pointer may be tested by determining whether the pointer's value falls within the range in which the table is stored. If the pointer does fall in that range, then the pointed-to function is invoked by looking up the address of the function in the entry that the pointer points to, and then making a call to the looked-up address. Otherwise, if the pointer falls outside the range in which the table is stored, an error results.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which the allowability of dereferencing a data pointer may be checked.

FIG. 2 is a block diagram of an example scenario in which the allowability of dereferencing a function pointer may be checked.

FIG. 3 is a block diagram of an example way to use a stack to store ATLVs.

FIG. 4 is a block diagram of an example way of identifying which addresses are legitimate pointer targets.

FIG. 5 is a flow diagram of an example process in which it may be determined whether to dereference a pointer.

FIG. 6 is a flow diagram of an example process in which it is determined whether a function pointer may be dereferenced.

FIG. 7 is a flow diagram of an example process that may be used to consider legitimate target addresses from the different frames on the stack.

FIG. 8 is a flow diagram of an example process of handling errors.

FIG. 9 is a block diagram of example components that may be used in connection with implementations of the subject matter described herein.

### DETAILED DESCRIPTION

Computer programs may use runtime checks for various reasons. Runtime checks may help to detect bugs in a program. As another example, runtime checks may be used to detect and/or prevent certain program behaviors before a program can damage data or other programs.

One example of a runtime check is a memory access check. When a program attempts to access a memory location (e.g., by reading a datum at that location, or by writing to a location to update the datum stored there), a memory access check tests whether the program is allowed to access the address at that point in time. Another example of a runtime check is a control-flow integrity (CFI) check. Given an instruction that tries to execute code at an address (e.g., by calling or jumping to an address other than where the program counter currently points), a CFI check tests whether the program is allowed to execute code at that address. (Since calls and jumps both set the next instruction to be executed to a specific location in memory, they present similar issues from the perspective of control flow integrity. Thus in the description herein, the discussion of calls shall apply to jumps, and vice versa.)

The issue of whether an address can be accessed or jumped-to is particularly problematic when a program identifies the address by indirection, as in the case of pointer variables. For example if “a” is the name of a pointer to an integer (e.g., a variable declared as “int *a” in the C language), then the statement “*a=1” (which assigns the value “1” to whatever memory location “a” points to) may or may not be allowable depending on what value has been assigned to “a”. Similarly, if “pf” is a pointer to a function (e.g., a variable declared as “void (*pf)(void)” in C), then the function call “(*pf)( )” may or may not be allowable depending on what value has been assigned to “pf”. While the C language is one example of a language where this issue can arise, similar issues can arise in other languages. For example, similar issues can arise in C++.

Runtime checks may be implemented by inserting the code to perform the check into the program to be checked. The code to perform the check could be inserted by the compiler, or could later be inserted by post-compilation binary rewriting. There are various ways that the checking code could perform the pointer check, although some are more efficient than others. For example, there could be a whitelist of addresses to which accesses or jumps are allowed, or a blacklist of addresses to which accesses or jumps are disallowed. For every instruction that accesses or jumps to such an address, checking code could be inserted that looks at the value of the pointer variable that is about to be dereferenced (“a” and “pf” in the preceding examples), and compares that value to the whitelist or blacklist. However, it may be inefficient to compare a pointer to every value on a list.

The subject matter described herein provides efficient ways of performing runtime checks under certain conditions. In one example, there may be a specific range of addresses that are allowed to be accessed or jumped-to (whether the jump occurs through a function call, a function return, or a jump-type instruction). For example, access might be allowed for addresses in the range 0x1000 through 0x2000, so determining whether a pointer may be dereferenced simply involves checking whether the pointer value is in the allowable range. When using this scheme, a problem that arises is that many pointer variables are assigned to the addresses of address-taken local variables (ATLVs). E.g., if a and b are declared within a function as “int *a, b”, then “a=&b” assigns the pointer named “a” to the address of the local integer variable “b”. In this case “b” is an ATLV, since its address is taken by the unary “&” operator. “b”, as a local variable, would normally be implemented as a stack variable, whose address is determined by an offset from frame pointer for the current stack frame. The actual (absolute) address of “b” depends on where on the stack the frame is located for the instantiation of the function in which “b” is declared. The location of the frame can change across different instantiations of the function, and may change many times throughout the operation of the program. In other words, when a local variable is implemented as a stack variable, the range of addresses into which “b” falls at any given time is indeterminate.

In one example, the subject matter herein addresses the above-described problem by converting ATLVs to global variables. With ATLVs being treated as if they were global variables, the ATLVs may be assigned to non-stack addresses that fall within the allowable range. Thus, if pointer “a” has been assigned to the address of “b” (e.g., “a=&b”), and if pointer “a” is subsequently dereferenced (e.g., “c=*a”), then checking code can be inserted that verifies—prior to dereferencing “a”—that “a” has a value falling within the acceptable range. Since “b” is implemented as if it were a global variable, instead of a stack variable, the address of “b” does not change along with the movement of the stack while the program executes, and that address can be assigned in such a way that it is within the known range of addresses to which access is allowed.

Since recursion depends on the ability to use the stack to make a new copy of a function's local variables each time the function is instantiated, a policy may be implemented that bars recursion on functions that use ATLVs. A compiler may enforce this policy by checking for recursive function calls (and, perhaps, by attempting to detect mutually-recursive calls). Or there may simply be a convention that programmers are expected to follow, in which they avoid using ATLVs from any functions that are called recursively. (While the foregoing provides one way to implement runtime checks on pointers when recursion on functions containing ATLVs is avoided, other techniques are described herein that may be used to implement runtime checks when recursion on such functions is allowed.)

Function pointers may be handled in a similar way to ATLVs. For example, if “fun” is the name of a function (declared, for example, as “extern void fun(void)”), and “pf” is a pointer to a function (declared as void (*pf)(void)), then a function call may be made by the sequence of statements “pf=fun; . . . (*pf)( );”. Those functions that are assigned to function pointers may have their addresses stored in a table, where the starting and ending addresses of the table are known. The code to implement these statements may be compiled (or rewritten after compilation) so that assignment of the function pointer (e.g., “pf=fun”) adds an additional level of indirection to function pointers, and assigns “pf” to be the address of the table entry that contains the address of “fun”, instead of assigning “pf” to the address of fun itself. The dereferencing statement (e.g., “(*pf)( )”) then may be compiled (or rewritten) so that instead of jumping to the address stored in “pf”, checking code first determines whether “pf” points to an address that falls between the known starting and ending addresses of the table and—if so—jumps to the address contained within the table entry that “pf” points to. In this way, the allowability of dereferencing a function pointer may be determined by a simple range check, just as in the case of ATLVs that have been implemented as global variables. (Variables and functions may both have their addresses taken, and the addresses may be assigned to pointers. In this sense, address-taken variables and address-taken functions present some of the same issues, and may be collectively referred to herein as address-taken objects.)

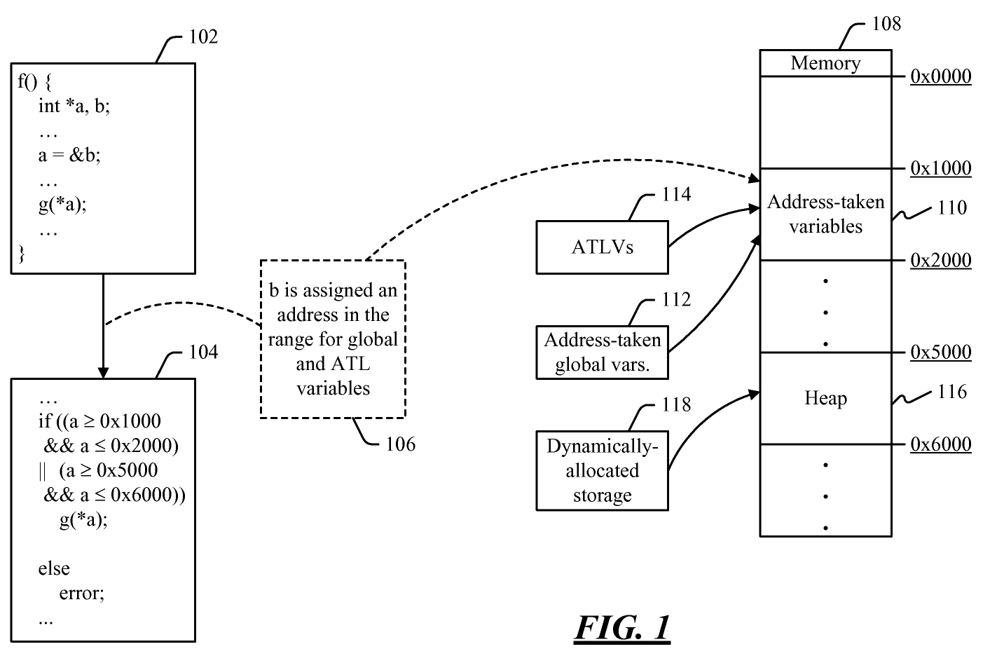

Turning now to the drawings, FIG. 1 shows an example scenario in which the allowability of dereferencing a pointer may be checked. Program 102 is an example program in which a pointer is assigned and dereferenced. Program 102 shows a simple example of such a program, although the principles described herein may be applied to any program of arbitrary size or complexity. The example programs shown in the drawing and discussed herein are written in a high-level pseudo-code, which employs a C-like syntax for pointers. Specifically, in the examples, “&” is a unary operator that returns the address of a variable, and “*” is the dereferencing operator that stands for the contents of the memory location whose address is contained in a variable. Thus, if a variable is named “x”, then “&x” refers to the address (either an absolute, or an address relative to some location on the stack) at which x is stored, and if “y” is the name of a pointer variable, then “y” refers to whatever y points to. Thus, “y=&x” makes y point to x, and “x=*y” makes x equal to whatever is stored at location y. Additionally, in the discussion of function and function pointers, we follow the C-like convention that the postfix operator “( )” (with or without arguments) calls a function, and that function pointers are declared with the syntax “type1 (*pf)(type2)”, which declares “pf” as a pointer to a function that takes input of “type2” and returns a value of “type1”. Moreover, in keeping with the C-like syntax, a function name evaluates to the starting address of the function itself, so, if “f” is the name of a function, then the statement “pf=f” makes pf point to f (i.e., the assignment is not written as “pf=&f”). Although this high-level pseudo-code is used in the examples, the actual programs described may be in any language (e.g., C, Java, C#, machine language (whether for a physical or virtual machine), etc.).

Program 102 defines a function, “f”, within which two local variables, “a” and “b”, are declared. “a” is a pointer to an integer, and “b” is an integer. Within “f”, the address of “b” is taken and stored in pointer variable “a” (by the statement “a=&b”). Later, “a” is dereferenced. In the example of program 102, “a” is dereferenced so that it can be used as an argument to the function “g”, although “a” could be dereferenced for any reason. Since the address of “b” is taken, “b” is an ATLV.

In order to support runtime checks, program 102 is converted into program 104. The conversion of program 102 into program 104 involves certain modifications to the actions performed by the program. This conversion might be performed by a compiler, by a binary rewriter, or by a program that converts a program in a source language into a new program in that source language. In general, the conversion can be performed by any type of program, and may or may not involve translation of the program from a source language to a target language. However, a salient feature of the conversion is that it adds appropriate runtime checks to the program, and/or makes certain modifications to the treatment of certain variables and functions, as described below. For ease of understanding the programs, both programs 102 and 104 are shown in the same high-level C-like pseudo-code that is used throughout the description and drawings herein, although either, both, or neither of these programs might be machine language. For example, program 102 may be written in source code and the conversion may be performed as part of the compilation process, in which case program 104 would be in machine language. Or, the conversion may be performed as part of a post-compilation binary re-writing process, in which case both programs 102 and 104 may be in machine language. (In some sense, programs 102 and 104 are different versions of the same program; thus, the subject matter herein may sometimes refer to one program being converted to another program, or may refer to one version of a program being converted to another version of that program.)

As part of the conversion of program 102 into program 104, it is determined that b is an ATLV, since there is a statement in function f that takes the address of b. Thus, b may be assigned an address in the range of memory that is used for global and address-taken local (ATL) variables (block 106). Memory 108 (which may, for example, be a physical memory such as a random-access memory implemented on one or more semi-conductor chips) has addresses 0x0000 and up. Certain address ranges of memory 108 are designated for certain purposes. For example, range 110 (from address 0x1000 to 0x2000) is designated for global variables (such as address-taken global variables 112) and ATLVs 114. Range 116 (from address 0x5000 to 0x6000) is designated as part of the heap, and is used for dynamically-allocated storage 118, such as the memory locations returned by calls to the malloco function. Use of range 110 could be limited to address taken variables (both address-taken local variables and address taken global variables). Limiting the use of range 110 in this way would allow a runtime check to detect the situation where a pointer happens to point to a global variable, but one whose address was not taken. Or, a more liberal implementation might allow all non-stack variables (both global variables and address-taken local variables) to be stored together in range 110.

Pointers are normally set to point to address-taken variables or to dynamically allocated blocks of memory on the heap. There are legitimate examples in which pointers are set to arbitrary values other than variable addresses or heap locations, but it is difficult to track or control the behavior of a program when pointers can be set to arbitrary values. Therefore, when the behavior of a program is to be regulated (e.g., to prevent the program from damaging data or other programs), the program may be written under a restrictive set of rules in which pointers can only be set to the addresses of variables or locations on the heap (or certain ranges of the heap). In order to enforce this restriction at runtime, the process of converting program 102 to program 104 may add a runtime check that verifies, prior to dereferencing a pointer, that the pointer is either the address of a variable (or perhaps the address of a field within a structure), or a heap location. In the example of FIG. 1, it is easy to determine whether a pointer points to such a location, because all global and ATL variables are in range 110, and all heap locations are in range 116. (The runtime check may, or may not, check the alignment of the pointer. That is, if the pointer points to a four-byte integer that is expected to be aligned at an address divisible by four, the runtime check may check that the address pointed both is in the correct range and has the correct alignment, or it may check merely that the address is in the correct range.) Putting the address-taken variables and the heap in contiguous locations simplifies the process of testing whether a pointer points to a legitimate location, since the test merely involves determining if the pointer's current value falls within one of the acceptable address ranges. (However, using contiguous block of memory to store the address-taken variables is not the only way to identify legitimate pointer targets; other ways are described below.)

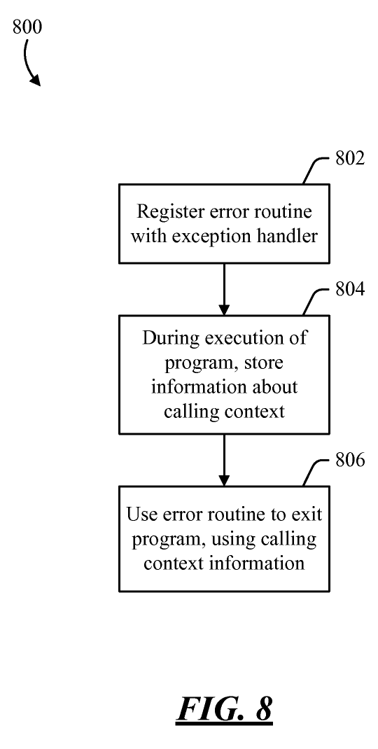

Assuming that the global and ATL variables, and the heap, are stored in contiguous locations, as shown in the example of FIG. 1, testing a pointer before dereferencing is relatively simple, as shown in the code example of program 104. In that example, prior to dereferencing pointer “a” (which occurs in the statement “g(*a)”), range check is performed. Since ATL and global variables have addresses in the range 0x1000 to 0x2000, the converted program tests whether “a” is in the range 0x1000-0x2000 (where global and ATL variables are stored), or 0x5000 to 0x6000 (where the heap is located). If so, then the pointer is dereferenced. Otherwise, an error occurs. (An example way to handle errors is described below in connection with FIG. 8.)

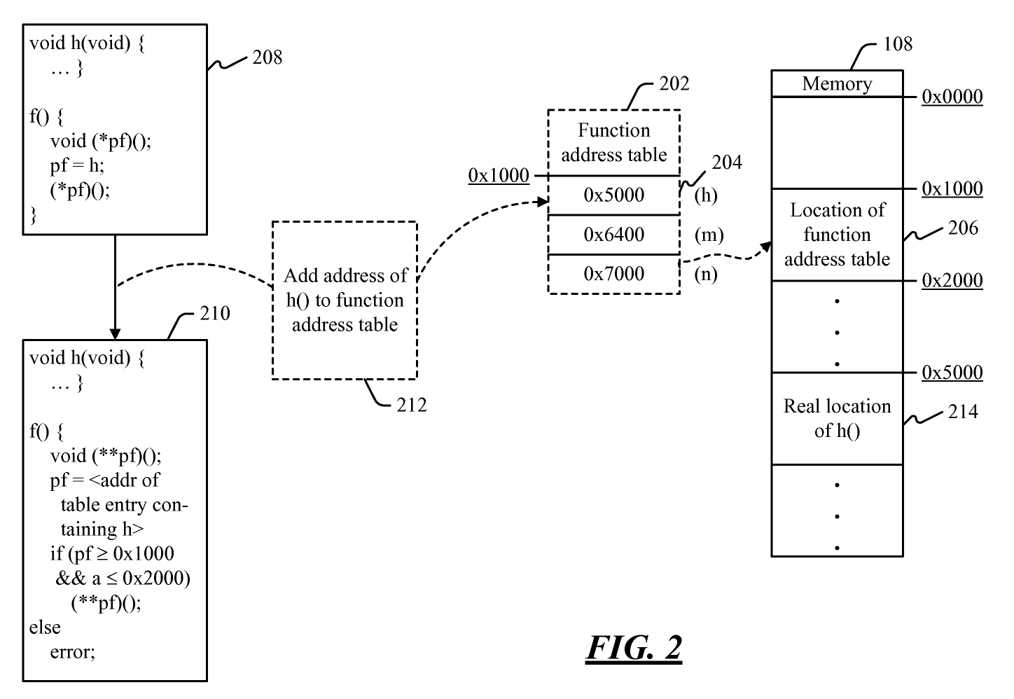

FIG. 1 shows a way to check whether a pointer to a memory location may be dereferenced. FIG. 2, on the other hand, shows a way to check whether a pointer to a function may be dereferenced. The technique shown in FIG. 2 adds an extra level of indirection to function pointers. A function is identified by its starting address, so normal function pointer acquires the starting address of a function. However, in the example of FIG. 2, the starting addresses of functions are put into table 202, and function pointers in a program are then modified so that—instead of pointing to the starting address of a function itself—point to the entry in table 202 that contains the function.

For example, function h (reference numeral 214) is stored in memory 108 starting at address 0x5000. Table 202 contains an entry 204 that corresponds to function h. Entry 204 contains the starting address of h, which is 0x5000. (Table 202 may also contain entries for other functions, such as m and n; the entries for functions m and n show these function, by way of example, as starting at addresses 0x6400 and 0x7000.) A function pointer, pf, would normally be made to point to h by assigning, to the pointer, the value 0x5000—i.e., the starting address of f. Then, the function pointed to by pf would normally be invoked by dereferencing pf, and then jumping to the dereferenced value. When table 202 is used, a function may be pointed to by pointing to the entry that contains the target function. Thus, if a pointer is to be made to point to f, it may be assigned the address of entry 204 in table 202—i.e., 0x1000. In order to invoke the function, instead of jumping to the address contained in the pointer, the program may jump to the address stored in the table entry that the function points to. The table, and the way in which functions listed in the table are called, could be implemented in various other ways—e.g., the table could contain an actual instruction to call the function (or an instruction to jump to an arbitrary address, if table is being used for jumps). Typically, the entries in the table have the same size so they can be used in a uniform manner. In one example, the pointer contains the actual address of the entry in the table that describes the function, although in another example the starting address of the table is known and the pointer contains some offset into the table to describe the location of a particular entry. (It is noted that, when a table is used, the starting address of the function is the target of the pointer, although the target may be accessed indirectly by looking up that start address in a table entry identified by the pointer's contents.)

By using the above-described technique with function pointers, it is possible to implement runtime checks on certain aspects of flow control by checking that a pointer value falls within a certain range, similarly to how checks are made on the data pointers described in connection with FIG. 1. Table 202 is stored within a contiguous range 206 of addresses in memory, which, in the example of FIG. 1, is shown as the range 0x1000 to 0x2000. If function pointers in a program are made to point to table entries in this contiguous range rather than to the functions themselves, checking that a function pointer references a legitimate function may be performed simply by verifying that the pointer points to a properly aligned address within range 206.

Programs 208 and 210 illustrate how a runtime check on function pointers may be implemented. Program 208 contains code that invokes a function through a pointer. Program 208 defines two functions, named f and h. Function f invokes h by assigning the address of h to a pointer named pf, and then dereferencing the pointer. Program 208 undergoes a conversion process, which converts program 208 into program 210. The conversion process may recognize that h is assigned to a function pointer, and thus puts the address of h into table 202 (at entry 204). The conversion process then changes the code so that, in effect, pf points to a function pointer, instead of pointing to a function itself, and the address of h is added to table 202 (block 212). In program 208, the statement “pf=h” assigns the starting address of h to pf. In the converted program 210, this statement is changed so that pf is set to the address of the entry 204 of table 202 that contains the address of h. Thus, in program 208, pf has the value 0x5000 (the starting address of h), and in program 210 pf would have the value 0x1000 (the address of entry 204). With the usage of pf modified in this way, program 210 contains a runtime check on the value of pf, which tests whether pf is in the range in which table 202 is stored—i.e., whether pf is between 0x1000 and 0x2000. If pf falls within this range, then the program jumps to the address stored in the table entry that pf points to; otherwise, an error occurs. In the example of program 208, the operation of jumping to the address stored in the entry pointed to by pf is shown by a simple double-dereferencing (i.e., “** pf”), and thus the declaration of pf is converted to a pointer to a pointer to a function (“void (**pf)(void)”). However, the actual process of looking in entry 204 and jumping to the address contained therein might be performed somewhat differently from a simple double dereferencing, depending on how entries in table 202 are formatted or organized. (In one example, the pointer may be checked to determine if the address it contains is in alignment with the table entries.)

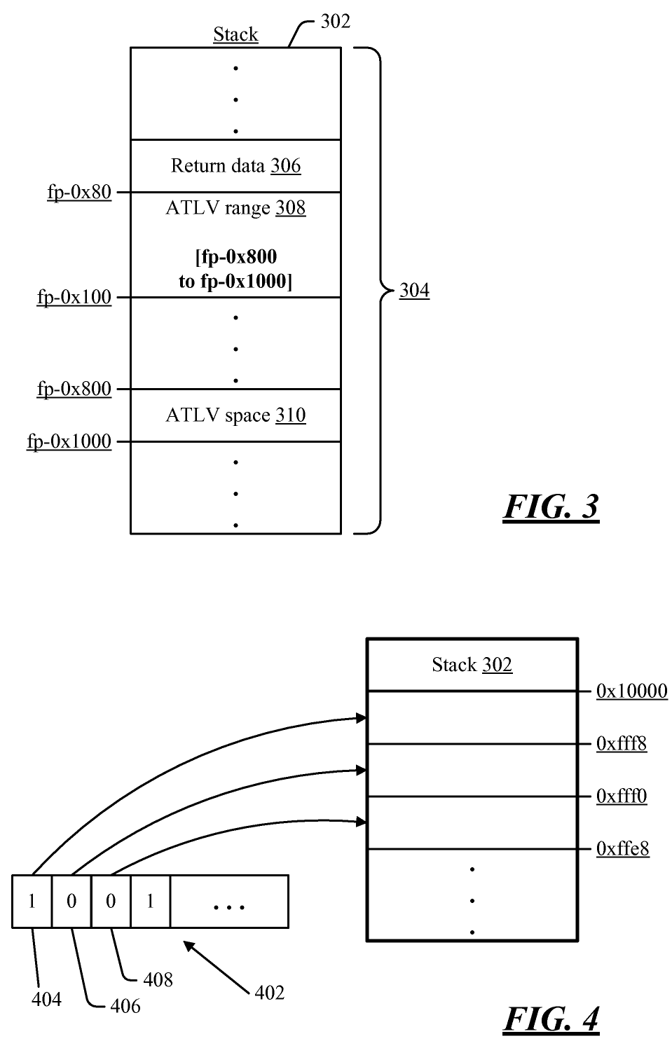

In the discussion above of FIG. 1, ATLVs are stored in a memory location other than the stack. Storing ATLVs in such a location makes it simple to determine whether a pointer is pointing to an ATLV. However, as discussed above, this design involves restricting the use of recursion, since recursion involves the use of a stack to store local variables. FIG. 3 shows an example way to use the stack so that ALTVs can be stored on a stack 302 while also supporting the type of runtime checks described above. In this way, runtime checks on pointers may be implemented without imposing a restriction on the use of recursion.

For the purpose of illustration, a particular frame 304 is shown on stack 302. Frame 304 may be the frame that corresponds to a particular instantiation of a particular function. Frame 304 starts, in this example, at some address (e.g., 0x10000), and includes addresses from that address downward. When frame 304 is the current frame, a frame pointer (marked as “fp”) is set to the starting address of the frame, and locations on the stack are described as offsets from fp—e.g., fp-0x100, fp-0x800, etc. Frame 304 contains return data 306 beginning at location fp-0x80. Return data 306 describes how to unwind the stack to the previous frame. It may include the return address—i.e., the address to which the program counter is to be set when the current function returns, which is usually the next instruction after the call to the current function. It may also include the starting address of the prior frame.

Frame 304 also contains an ATLV range 308, which indicates the range of addresses on stack 302 where ATLVs may be stored. In this example, ALTV range 308 is stored at address fp-0x100, and indicates that the ATLVs themselves are stored at addresses in the range of −0x800 to −0x1000 relative to the frame pointer. In this example, range 308 is expressed in terms of offsets from the frame pointer, although range 308 could also be expressed as absolute addresses.

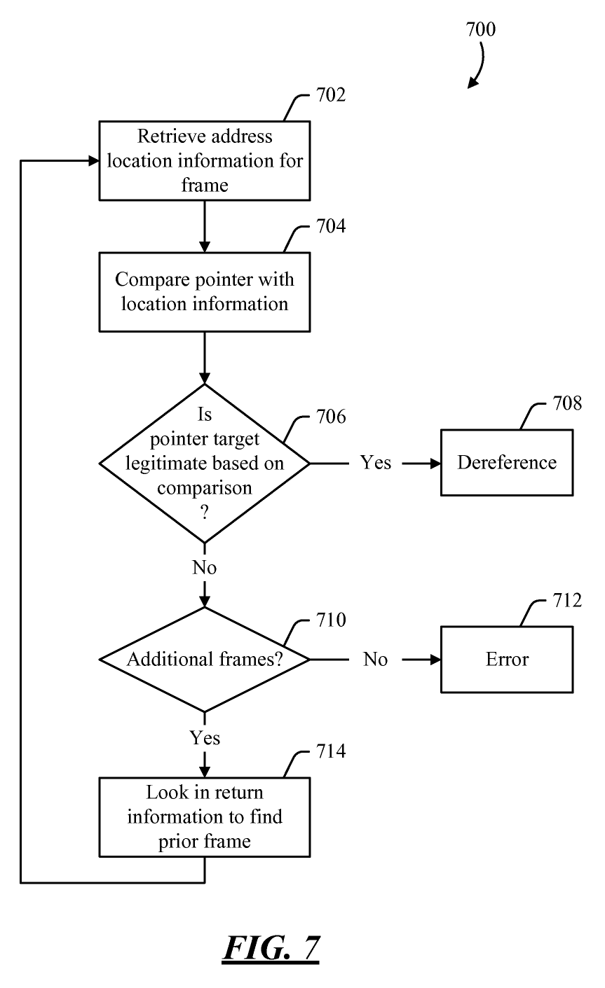

ATLV space 310 is the location on the stack where ATLVs may be stored for the current frame. ATLV space 310 is located, in this example, at fp-0x800 to fp-0x1000, as indicated by ATLV range 308. Since the ATLVs for a given frame are stored in a known region of the stack, it is possible to test pointers, prior to dereferencing, in a manner similar to that described above. As previously described, before dereferencing a pointer, a runtime check may be performed to determine if the pointer has a value within a specified range of addresses. When ATLVs are stored within a known region of a frame, that region may be discovered by looking at the ATLV range for that frame (e.g., ATLV range 308). The pointer may be tested to determine whether it points to an address in that range. If the pointer points to an address within that range, then the pointer is considered legitimate and may be used. However, if the pointer does not point to an address in that range, there is a possibility that it points to a legitimate address from another frame. Thus, return data 306 may be used to identify the prior frame. The prior frame has a structure similar to frame 304 (i.e., it may have it own return data, ATLV range, and ATLV space). Thus, the runtime check can walk the stack backward to determine whether the pointer points to a legitimate ATLV. (An example process for making this determination is discussed below in connection with FIG. 7.)

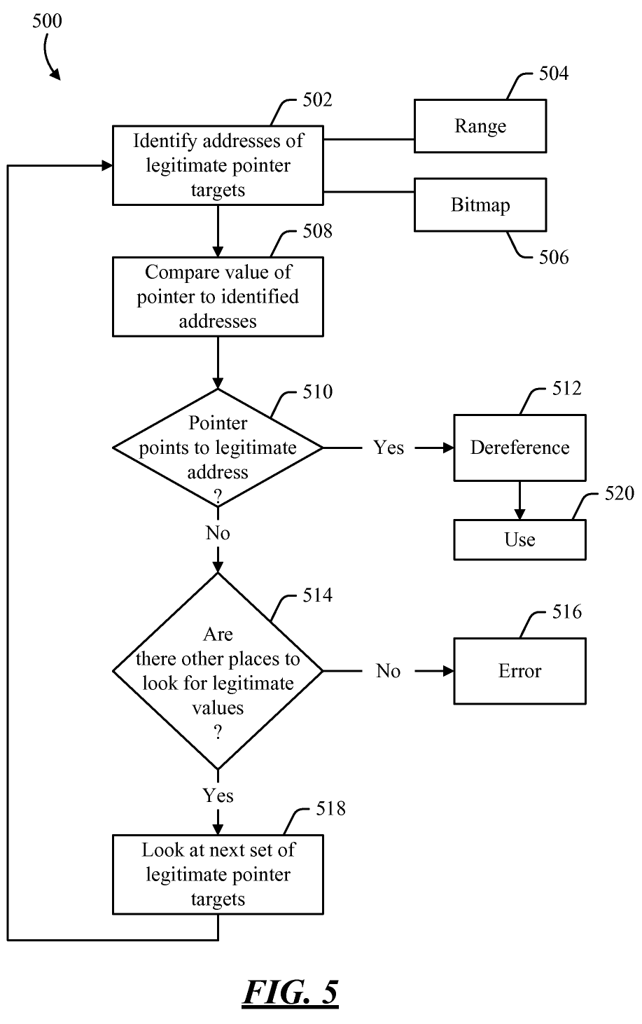

The technique described in connection with FIG. 3 may be used when ATLVs are confined to known range(s) on the stack. However, it is possible to check whether a pointer points to a legitimate address, even when ATLVs are arbitrarily dispersed throughout the stack. FIG. 4 shows an example way of identifying which addresses are legitimate pointer targets, even when ATLVs are not confined to particular range(s) within the stack.

In FIG. 4, stack 302 is divided into blocks. In the example shown, the blocks are each eight bytes long, although blocks of any size (arbitrarily small or arbitrarily large) could be used. Bitmap 402 identifies which of the blocks are legitimate pointer targets. Each bit in bitmap 402 corresponds to a block of memory in the stack, and is set to either one or zero according to whether the addresses the block are legitimate pointer targets or not. Thus, bit 404 is set to one and indicates that addresses in the eight-byte range from 0x10000 to 0xfff8 are legitimate pointer targets. Bits 406 and 408 are set to zero, indicating that the blocks from 0xfff8-0xfff0, and 0xfff0-0xffe8, respectively, are not legitimate pointer targets. And so on. If the blocks are eight bytes in length, bitmap 402 takes 1/64 the space of the stack that it corresponds to—e.g., sixteen kilobytes of bitmap memory for each megabyte of stack memory. Thus, bitmap 402 allows for very fine-grained control of the addresses in the stack with relatively little memory.

When bitmap 402 is used to represent the allowable and non-allowable pointer targets on the stack, ALTVs can be stored on the stack while still allowing for runtime checks to determine whether pointers point to the ATLVs. Before dereferencing a pointer, the runtime check determines whether the address contained in the pointer variable is on the stack. If so, the runtime check examines the bit, within bitmap 402, that corresponds to the block containing the address, and then determines whether the pointer may be dereferenced based on whether the bit contains a one or a zero.

At this point, it is noted that FIGS. 1-4 show various ways of describing the set of addresses or locations that constitute legitimate pointer targets, although other ways of describing such a set of addresses or locations may be used.

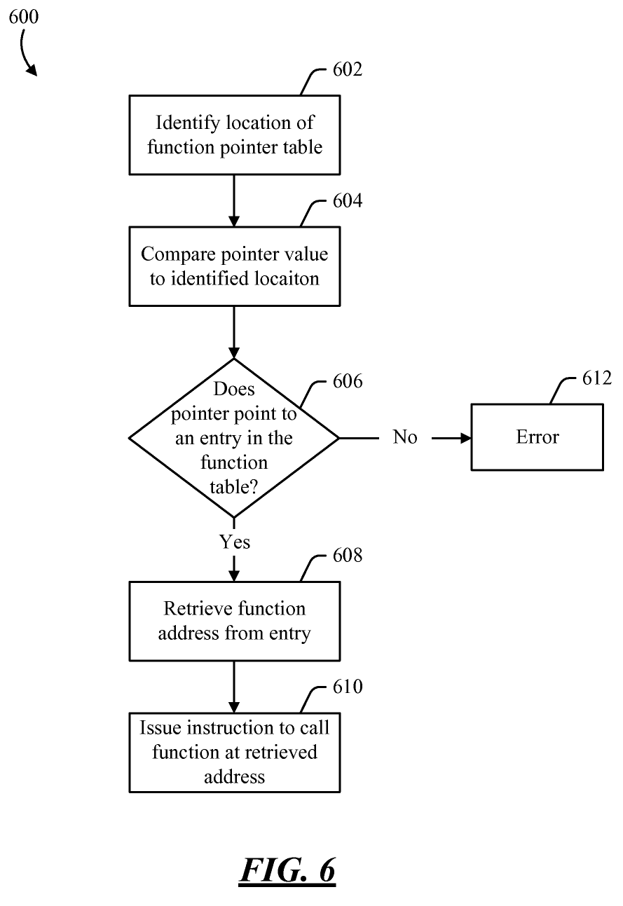

FIG. 5 shows an example process 500 in which it may be determined whether to dereference a pointer. Before turning to a description of FIG. 5, it is noted that the flow diagrams contained herein (both in FIG. 5 and in FIGS. 6-8) show examples in which stages of a process are carried out in a particular order, as indicated by the lines connecting the blocks, but the various stages shown in these diagrams may be performed in any order, or in any combination or sub-combination.

At 502, the memory addresses that constitute legitimate pointer targets are identified. These pointer targets may be identified in any manner. For example, as described above, the legitimate pointer targets may fall within one or more specific ranges (block 504), as in the case where global and ATLVs are put in a particular portion of memory, or where a portion of each stack frame is reserved for ATLVs. Another example of the use of such ranges is the technique described above in connection with FIG. 2, where a table containing the addresses of functions is stored in a stable that is located within a known range of memory addresses. A further example of how to identify those memory addresses that constitute legitimate pointer targets is to use a bitmap (block 506).

At 508, the value of a pointer to be dereferenced is compared to the addresses that were identified at 502. For example, the pointer may be compared to a range to determine if it falls within the range, or a pointer may be compared with a bitmap in the manner described above in connection with FIG. 4.

At 510, it is determined whether the pointer points to a legitimate target address—i.e., whether the pointer's value is among the set of addresses that constitute legitimate pointer targets. If the pointer does point to a legitimate target address, then the pointer is dereferenced (at 512), and the dereferenced value is used in some manner (at 520). FIGS. 1 and 2 show examples in which the dereferenced value is used as an argument to a function (the “g(*a)” call in FIG. 1, or is used as a pointer to the function to be called (the “(*pf)( )” call in FIG. 2). However, the dereferenced pointer may be used in any manner. Further examples of tangible uses of the dereferenced pointer include reading a datum from and/or writing a datum to a memory location pointed to by the pointer.

If the pointer is not found, at 510, to point to a legitimate target, then it may be determined, at 514, whether there are other places to look for legitimate target address (places other than the range, bitmap, or other construct that was considered at 502). As described above, there may be various different groups of addresses that are legitimate pointer targets, and these various groups of addresses are considered before aborting the dereferencing of a pointer. For example, if each frame on the stack has its own range of addresses to store ATLVs, then the runtime check may look to the previous frame on the stack, and may continue looking at previous frames until it either finds that the pointer is legitimate or reaches the beginning of the stack. As another example, ATLVs and the heap may be stored in different ranges of addresses, and process 500 may consider both of these ranges. If there is nowhere else to look for legitimate target addresses, process 500 concludes that the pointer target is not legitimate and proceeds to an error routine (block 516). If there are more places to look for pointer targets (e.g., another frame in the stack, another bitmap, etc.), then process 500 looks at the next set of pointer targets (block 518), and process 500 returns to 502 to compare the pointer in question to this next set of pointer targets.

FIG. 6 shows an example process 600 in which it is determined whether a function pointer may be dereferenced. At 602, the location of a function pointer table is identified. Table 202 (shown in FIG. 2) is an example of such a function pointer table. (The examples herein refer to a single function table, although several function tables could be used.) At 602, the range of addresses where the table is stored in memory may be identified.

At 604, the pointer to be dereferenced is compared with the range in which the table is stored. If the pointer points to an address within this range (as determined at 606), then the address of a function is retrieved from the entry that the pointer points to (at 608). An instruction is then issued to call the function located at the address retrieved from the table (at 610). If it is determined at 606 that the pointer does not point to an address in the range where the table is stored, then an error routine is invoked (at 612).

As noted above, each frame on the stack may contain a set of legitimate pointer targets, and the runtime check may walk back through the stack to determine whether a pointer points to a legitimate address from any frame generated by the chain of function calls that led to the top-level function call. FIG. 7 shows an example process 700 that may be used to consider legitimate target addresses from a chain of frames on the stack.

At 702, the location of legitimate addresses for a frame is retrieved. For example, ATLVs may constitute legitimate pointer targets. Moreover, as shown in FIG. 3, there may be a specific space in a frame where ATLVs are stored, and the range of addresses that define this space may also be stored on the stack. Thus, in one example, ATLV range 308 (shown in FIG. 3) is retrieved at 702.

At 704, the pointer to be dereferenced is compared with the information that was retrieved at 702. If, based on this comparison, the pointer points to a legitimate address (as determined at 706), then the pointer is dereferenced (at 708). Otherwise, it is determined (at 710), whether there are additional frames to consider. If there are no additional frames to consider, and if the pointer has not already been found to be legitimate, then an error routine is invoked (at 712). If there are additional frames, then, at 714, the process looks at the return information for the frame (e.g., return data 306, shown in FIG. 3) to find the previous frame. Process 700 then returns to 702 to determine whether the pointer points to an address that is defined as legitimate in the previous frame (e.g., an ATLV from a previous frame). (The process of tracing a chain of frames backward through the stack is sometimes referred to as walking the stack.) In addition to checking the pointer against legitimate addresses for the frames, process 700 also may check whether the address that the pointer points to is legitimate based on some other standard—e.g., if it points to an address on the heap, or to an address-taken global variable, etc. These checks may be made using techniques previously described.

As noted above, an error routine may be invoked if a pointer is not determined to point to a legitimate target address. Any type of error routine may be used. In one simple example, the error routine simply causes the program to exit. However, there may be reason to cause the program to handle the error more gracefully than a simple exit. For example, the program that is subject to runtime checking may be a driver that has been called by another program. If—due to a bad pointer—the driver has to stop before it completes the task for which it was called, there may be reason for the driver to return to its caller while also communicating the fact that it did not complete the task. FIG. 8 shows an example process 800 of handling errors that are generated when runtime checks fail.

At 802, an error routine is registered with an exception handler. Exception handlers typically allow programs to register error routines—e.g., a program may associate a particular error routine with a particular exception number, so that the error routine may be called if that exception number is raised. However, error routines that are registered in this manner are typically used to handle errors that arise outside of the program code itself. E.g., a program might register an error routine to handle exceptions that arise during calls to library routines, such as malloco. In the example of FIG. 8, an error routine is registered to handle errors that the program itself generates.

At 804, during execution of the program that is subject to runtime checks, information is stored about the calling context, so that this information will be available to the error routine in the event that the error routine has to cause a graceful exit from the program. If the error routine is then called, the error routine (at 806) uses the context information to exit from the program and to provide information to the caller that allows for a graceful exit. For example, if the program subject to runtime checks is a disk driver, and if the driver, prior to completing a requested disk write, has to exit as a result of the failure of a runtime check, the error routine may inform the program that requested the write operation that the operation did not complete (and/or how much of the operation did not complete). The data for which the write was requested, and the amount of data written to disk before the driver failed, are examples of context information that may be available to the error routine.

In using the techniques described herein, various implementation issues may arise. One such issue is limiting the amount of metadata that has to be stored in order to describe the legitimate pointer targets. (Metadata, in this example, refers to the data that describe which addresses are legitimate pointer targets—e.g., bitmaps, or range data that specifies the range of addresses containing ATLVs, global variables, the heap, etc.) Concurrency restrictions could be used to limit the amount of metadata to be stored. If, for example, a limit of n threads per core is imposed, this restriction limits the number of different versions of metadata that need to be stored for that core. Each thread would have its own set of legitimate target addresses and thus its own metadata. Moreover, there would be a version of the metadata for any interrupt service routines (ISR) that execute on the core, but the number of ISRs that can run concurrently on a core is limited by the (finite) number of Interrupt Request Levels (IRQLs). Thus, imposing a limit on the number of threads that are permitted to execute concurrently on a core imposes a finite bound on the number of versions of metadata that would be stored. The limit may be a simple numerical limit (e.g., no more than ten concurrent threads), or might involve more complex terms (e.g., no more than ten concurrent driver threads, or no more than ten threads generated by a particular list of applications, etc.)

Another implementation issue that may arise is how to store the metadata. Metadata exists on a per-thread basis, and thus the data may be stored in a way that leverages per-thread structures that already exist—e.g., by storing the metadata in a location that is saved on a per-thread basis as part of a thread's context. For example, the metadata may be stored at some location in memory, and a pointer to the metadata may be stored in an MMX register. Since such registers are saved as part of a thread's context, the active thread can access the pointer to its metadata using the pointer contained in the register. Other example places to store the pointer include the bottom of the thread's kernel stack, or in the Structured Exception Handler (SHE) control block at the FS[0] register.

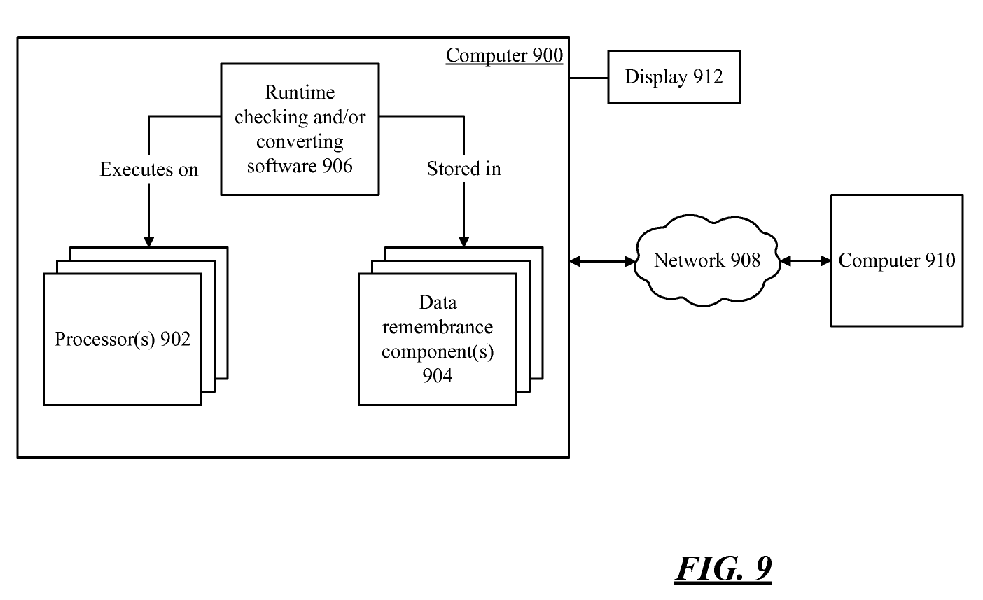

FIG. 9 shows an example environment in which aspects of the subject matter described herein may be deployed.

Computer 900 includes one or more processors 902 and one or more data remembrance components 904. Processor(s) 902 are typically microprocessors, such as those found in a personal desktop or laptop computer, a server, a handheld computer, or another kind of computing device. Data remembrance component(s) 904 are components that are capable of storing data for either the short or long term. Examples of data remembrance component(s) 904 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 900 may comprise, or be associated with, display 912, which may be a cathode ray tube (CRT) monitor, a liquid crystal display (LCD) monitor, or any other type of monitor.

Software may be stored in the data remembrance component(s) 904, and may execute on the one or more processor(s) 902. An example of such software is runtime checking and/or converting software 906, which may implement some or all of the functionality described above in connection with FIGS. 1-8, although any type of software could be used. Software 906 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 9, although the subject matter described herein is not limited to this example.

The subject matter described herein can be implemented as software that is stored in one or more of the data remembrance component(s) 904 and that executes on one or more of the processor(s) 902. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 902) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 900 may be communicatively connected to one or more other devices through network 908. Computer 910, which may be similar in structure to computer 900, is an example of a device that can be connected to computer 900, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store instructions that, when executed by a computer, cause the computer to perform acts comprising:
identifying a set of addresses that are legitimate pointer targets, said set of addresses including an address of an address-taken object;
comparing said pointer to said set of addresses;
determining that said pointer points to an address included among said set of addresses;
based on said determining, dereferencing said pointer to identify, within a physical memory, a target of said pointer; and
using said target to retrieve or update a datum located at said target, to invoke a function that starts at said target, or to jump to code at said target.

2. The one or more computer-readable storage media of claim 1, wherein said address-taken object comprises a local variable, and wherein said acts further comprise:
assigning said local variable to an address in a range,
wherein said determining comprises checking that said pointer points to an address within said range.

3. The one or more computer-readable storage media of claim 2, wherein said range is reserved for global variables and address-taken local variables.

4. The one or more computer-readable storage media of claim 2, further comprising:
converting said local variable from being located on a stack to being located not on said stack, wherein said local variable is part of a program written under a policy that bars recursion in functions that use address-taken local variables.

5. The one or more computer-readable storage media of claim 1, wherein said address-taken object comprises said function, and wherein said acts further comprise:
checking that said pointer points to an address within a range in which a table is stored; and
calling said function by retrieving said function's address from an entry in said table, wherein said pointer points to, or describes a location of, said entry.

6. The one or more computer-readable storage media of claim 5, further comprising:
adding said function's address to said table; and
converting said pointer from pointing to said function to pointing to said entry.

7. The one or more computer-readable storage media of claim 1, wherein said set of addresses comprises one or more blocks of memory on a stack, there being a bitmap that identifies which blocks of memory on the stack are in said set of addresses.

8. The one or more computer-readable storage media of claim 7, wherein said bitmap is stored in a location that is saved on a per-thread basis as part of a thread's context.

9. The one or more computer-readable storage media of claim 8, wherein said location comprises an MMX register, a location on the thread's kernel stack, or a Structured Exception Handler control block.

10. The one or more computer-readable storage media of claim 1, wherein said set of addresses are regions on a stack, each frame on said stack having a range that is part of said set of addresses, each frame having data that identifies the range for that frame.

11. The one or more computer-readable storage media of claim 10, wherein said acts further comprise:
walking the stack to find the range data for a plurality of frames.

12. The one or more computer-readable storage media of claim 1, further comprising:
registering an error routine with an exception handler, said error routine using information about a calling context to handle a failure that results when said pointer does not point to a legitimate pointer target.

13. The one or more computer-readable storage media of claim 1, further comprising:
imposing a limit on a number of threads that are permitted to execute concurrently.

14. A method of verifying a pointer, the method comprising:
identifying a set of locations that contains legitimate targets of the pointer, said pointer being in a function that has an address-taken local variable, said address-taken local variable being stored in said set of locations;
comparing the pointer to said set of locations;
determining that said pointer points to an address in said set of locations;
based on said determining, dereferencing said pointer; and
reading, writing, or executing data at said address.

15. The method of claim 14, wherein said function is part of a program that has a first version in which said address-taken local variable is stored on a stack, and wherein the method comprises:
converting said first version of said program to a second version of said program by changing said address-taken local variable from being stored on said stack to being stored in a non-stack location in which global variables are stored, said non-stack location being part of said set of locations.

16. The method of claim 14, wherein said set of locations comprises a range of addresses, and wherein said determining comprises:
determining that the address pointed to by said pointer is within said range.

17. The method of claim 14, wherein said set of locations comprises a range for each of a plurality of frames on a stack, and wherein said determining comprises:
determining that said pointer does not point to an address in the range for a first one of the frames;
looking at return information in the first one of the frames to identify a chain of frames; and
determining that said pointer points to an address that is in the range for one of the frames in the chain of frames.

18. A system for verifying a pointer in a program, the system comprising:
a processor;
a memory that stores a stack and that further stores non-stack locations;
a conversion component that converts a first program into a second program by converting an address-taken local variable from being stored on said stack to being stored in a range, within said non-stack locations; and
a checking component that determines whether a pointer in said second program points to a location in said memory that is within said range, and that either allows said pointer to be dereferenced or invokes an error routine based on whether said pointer points to a location in said memory that is within said range.

19. The system of claim 18, wherein said error routine is registered with a structured exception handler, and wherein said second program invokes said error routine by raising an exception when said pointer does not point to a location that is within said range.

20. The system of claim 18, wherein the system imposes a condition on writing of said first program in which recursion is not allowed for functions that use address-taken local variables.
